(19) United States
(12) Patent Application Publication
(10) Pub. No.: US 2011/0234600 A1
(43) Pub. Date: Sep. 29, 2011

(54) Client/Server Waveform Viewer Using Bitmaps

(75) Inventor: Alain M. Dargelas, Milpitas, CA (US)

(73) Assignee: Synopsys, Inc., Mountain View, CA (US)

(21) Appl. No.: 12/731,079

(22) Filed: Mar. 24, 2010

(51) Int. Cl. G06T 11/20

(52) U.S. Cl. 345/442

(57) ABSTRACT

Improving on the waveform viewing technology can advantageously address the industry's need for speedup and capacity of existing solution. As described herein, making data manipulation local and bounded can facilitate tremendous speedup. The waveform viewer can process data on-demand where the user explicitly specifies signals and a desired window (i.e. range). Operations including, but not limited to, zoom, pan, scan, etc. on the waveform viewer can be sent to the waveform servers in the form of a query containing the visualization parameters (e.g. number of pixels), which in turn compute bitmaps (or other waveform images) that are sent back to be displayed.

### BACKGROUND OF THE INVENTION

1. Field of the Invention

The present invention relates to computer images of waveforms and in particular to improving viewing speed and access to waveform information by using bitmaps.

2. Related Art

Simulation can be used in integrated circuit (IC) design to check the integrity of the design and to predict circuit behavior. In a typical simulation, a simulator can generate a waveform file, wherein constituent waveforms in the file represent signals in the design over time, each waveform corresponding to one node in the IC design. Many signals vary between values of logic “0” and logic “1”. Some signals in the IC design may have a “Z” value. For example, multiple drivers driving a single net in the design could result in contention (e.g. one driver providing logic “0” and another driver providing logic “1”). To resolve this conflict, one driver is characterized as “hanging”, thereby allowing the other driver to control the net. Yet other signals in the IC design may have an “X” value. For example, a flip-flop before initialization has an unknown state. This unknown state is called the “X” value.

Simulating current IC designs can generate a waveform file including hundreds of gigabytes of information. In general, users are concerned with only a subset of nodes in the IC design, e.g. the nodes with potential problems. For example, once initialization occurs, nodes still having X values can be characterized as problem nodes. The waveform file can be accessed to view the waveform associated with each problem node and its driving nodes (sometimes called a cone of logic) using a schematic of the IC design to determine the cause of the problem. Unfortunately, even downloading information regarding one waveform may take hours. However, once that waveform is accessed and downloaded from the file, the debugging process including zooming in on portions of the waveform or scrolling through the waveform can be both fast and interactive.

Therefore, a need arises for a method of processing the waveform file that can reduce user access time while preserving waveform data.

### SUMMARY OF THE INVENTION

Improving on the waveform viewing technology can advantageously address the industry's need for speedup and capacity of existing solution. As described herein, making data manipulation local and bounded can facilitate tremendous speedup. The waveform viewer can process data on-demand where the user explicitly specifies signals and a desired window (i.e. range). Operations including, but not limited to, zoom, pan, scan, etc. on the waveform viewer can be sent to the waveform servers in the form of a query containing the visualization parameters (e.g. number of pixels), which in turn compute bitmaps (or other waveform images) that are sent back to be displayed.

Specifically, a method of generating waveform images is described. In this method, an integrated circuit design can be simulated. In one embodiment, the simulating can be performed by both a software tool and a hardware tool. The simulated output can be converted into temporally organized waveform data.

Localized rendering of the temporally organized waveform data can be provided based on user input and waveform viewer resolution. The user input includes zooming and/or scrolling functions associated with the waveform viewer.

The zooming functions can include compacting the waveform images for the waveform viewer, wherein the compacting includes deleting the underlying waveform data and using a visual representation indicating underlying activity. The scrolling functions can include deleting the unviewed waveform images, caching the still-viewed waveform images, and loading a limited number of to-be-viewed waveform images.

The waveform images can then be loaded into the waveform viewer. The waveform images can include bitmaps files, JPEG files, pixmaps, PPMs (portable pixmap format), PGMs (portable graymap format), PBMs (portable bitmap format), PNMs (portable anymap format), or an instruction set (for example, but not limited to, drawing rectangles and other geometries).

A system for generating waveform images is also described. This system can include a plurality of simulators, value change databases, and waveform servers. The simulators can simulate an integrated circuit design. The value change databases can convert the simulated output into temporally organized waveform data. The waveform servers can provide the localized rendering of the temporally organized waveform data based on user input and waveform viewer resolution. A waveform viewer can be provided for loading of the waveform images.

In one embodiment, the plurality of simulators can include both software and hardware tools. The waveform viewer can include zooming and/or scrolling buttons in a toolbar. The use of the zooming button can allow compacting of the waveform images, wherein the compacting includes deleting the underlying waveform data and using a visual representation to indicate underlying activity. The use of the scrolling button can trigger deleting the unviewed waveform images, caching the still-viewed waveform images, and loading a limited number of to-be-viewed waveform images.

### BRIEF DESCRIPTION OF THE FIGURES

FIG. 1 illustrates an exemplary system for generating waveform images.

FIG. 2 illustrates an exemplary set of waveform images associated with a set of signals in an IC design.

FIG. 3 illustrates a set of compacted waveforms corresponding to the waveform images of FIG. 2.

FIG. 4 illustrates a simplified representation of an exemplary digital ASIC design flow.

### DETAILED DESCRIPTION OF THE DRAWINGS

In accordance with one aspect of the invention, only a portion of a waveform image is loaded at any point in time. Specifically, only the portion of the waveform image being viewed by the user is loaded.

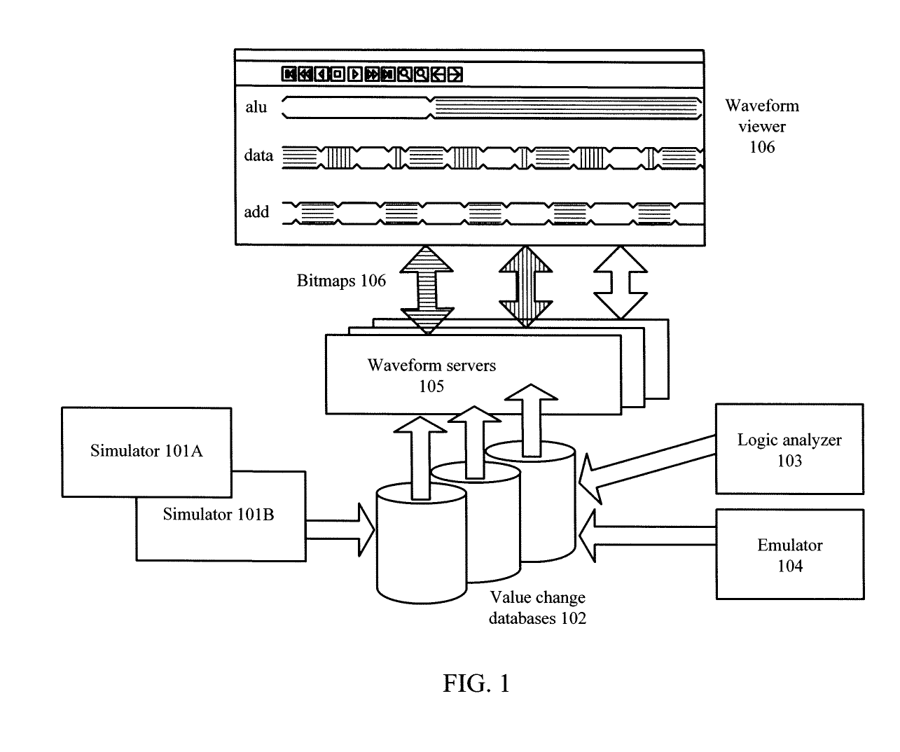

FIG. 1 illustrates an exemplary system for generating waveform images. In one embodiment, an IC design can be divided into two parts: a first part to be analyzed by software and a second part to be analyzed by hardware. The software part, e.g. that part of the design that cannot be synthesized, can be analyzed by one or more simulators. In FIG. 1, simulators 101A and 101B are shown, but other embodiments could include more or less simulators. The hardware part, e.g. that part of the design that can be synthesized, can be analyzed by an emulator and/or a logic analyzer (an oscilloscope). In FIG. 1, an emulator 104 and a logic analyzer 103 are shown, but other embodiments could include multiple emulators, multiple logic analyzers, or a combination one or more emulators and logic analyzers. In one embodiment, dividing the IC design into the two parts can be done by referring to the constructs used in the language describing the IC design. For example, the constructs in Verilog can identify whether a component is synthesizable, thereby providing the above-described dividing.

Notably, simulators 101A and 101B, emulator 104, and logic analyzer 103 can analyze data in parallel, thereby accelerating the analyzing of the IC design. In one embodiment, emulator 104 (e.g. implemented using an FPGA) can be used for as much of the IC design analysis as possible because emulator 104 can be significantly faster than simulators 101A and 101B. This analyzed data in the form of waveform files for the complete IC design can be assembled and positioned temporally (i.e. synced) by using a plurality of value change databases 102.

A plurality of waveform servers 105 can transform the synched waveform files output by value change databases 102 to generate bitmaps 106 for a waveform viewer 106. Note that simulation, whether performed by simulators 101A and 101B, emulator 104, or logic analyzer 103 is relatively quick compared to the bitmap preparation. In one embodiment, to improve efficiency of waveform servers 105, the waveform files generated by simulators 101A and 101B, emulator 104, and logic analyzer 103 can be allocated in substantially equal size to each of value change databases 102, thereby allowing value change databases 102 to perform their processing in parallel (i.e. using only one value change database may potentially create a processing bottleneck).

In accordance with another aspect of the invention, simulators, emulators, and logic analyzer having different data formats can still be used in the above-described configuration. That is, as long as the appropriate API (application programming interface) including random data access to the waveform data is provided or loading by time segments of the data, then any vendor (or multiple vendors) may provide their own simulator(s), emulator(s), or logic analyzer(s).

In accordance with one aspect of the invention, the resolution of the screen associated with waveform viewer 106 can determine how the waveform image is displayed. Thus, waveform servers 105 (also called the “server”) can compute bitmaps 106 (or any other form of picture image) given the screen resolution and the window (i.e. the range) of the waveform to be displayed. Once computed, waveform servers 105 can then send bitmaps 106 to the rendering engine, i.e. waveform viewer 106 (also called the “client”). Thus, the bulk of the data transferred between the client and the server is an image (noting that the client may be communicating the resolution data to the server using another data type). Notably, the server and the client may be in the same process or may be at different nodes of the network. In one embodiment, the server may use C or C++ coding for computational efficiency, whereas the client may use more user friendly GUI (graphic user interface) frameworks like Tcl/Tk, Java, C#, QT, Motif, or an Internet Browser-based coding.

In one embodiment, each waveform server 105 can generate a particular set of waveform bitmaps associated with corresponding signals. Thus, waveform servers 105 can communicate with waveform viewer 106 to generate one screen showing multiple waveforms in one window. Thus, the client can provide the “stitching” of bitmaps 106 to form the window of waveforms. In one embodiment, an initial waveform view screen can start at time “0” and the user can use zoom functions to determine the desired window. The user can also select the signals (and thus their associated waveforms for viewing) from a set of all signals or from a subset of all signals by using a scroll function.

As the user proceeds temporally through the waveform, information regarding that portion of the waveform can be loaded by windows, i.e. once again limiting the amount of information that is loaded from the waveform file.

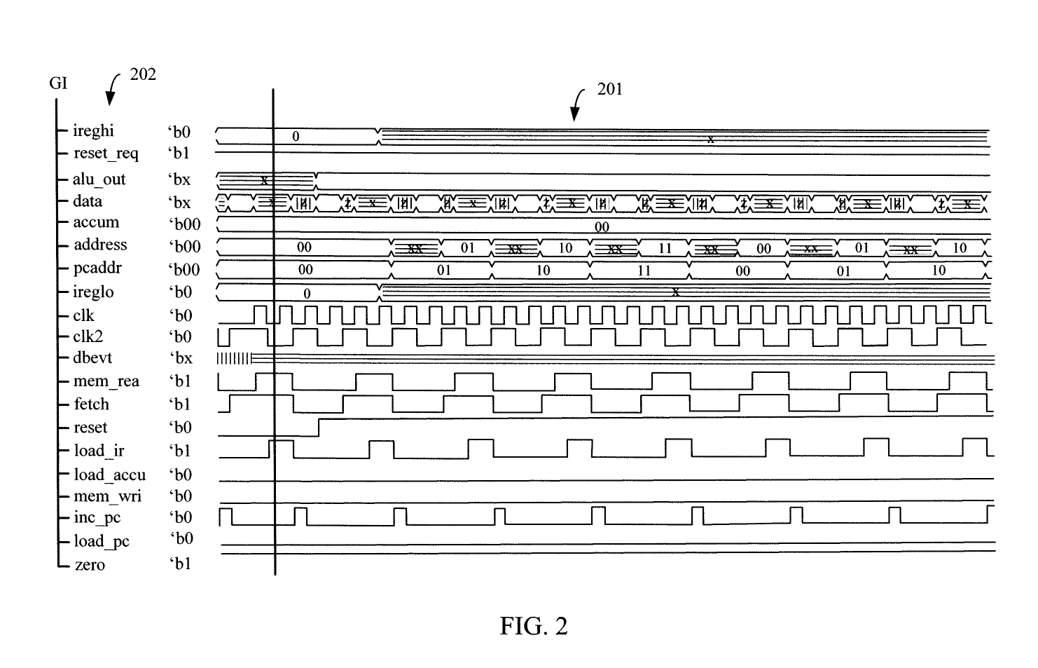

FIG. 2 illustrates an exemplary set of waveform images 201 associated with a set of signals 202 in an IC design. Note that the second column shows the values of the signals (first column) at the time pointed to by the time marker (vertical line across all signals positioned by mouse click on the waveform). Those values are being retrieved from the server by a similar query used to create the bitmap, i.e. bounded to the particular time and list of signals visible on the screen. In one embodiment, different colors for different portions of a waveform can indicate their logic states. For example, a portion of a waveform having an x state could be shown with a fill pattern of red lines (shown as a horizontal line fill pattern in FIG. 2), whereas another portion of that waveform having a z state could be shown with a fill pattern of blue lines (shown as a vertical line fill pattern in FIG. 2). In another embodiment, a portion of a waveform representing a bus could be labeled with its constituent line values, e.g. “00”, “01”, “10”, “11”, “xx”, etc for two lines. Yet other waveforms represent binary transitions between logic “1” and logic “0”.

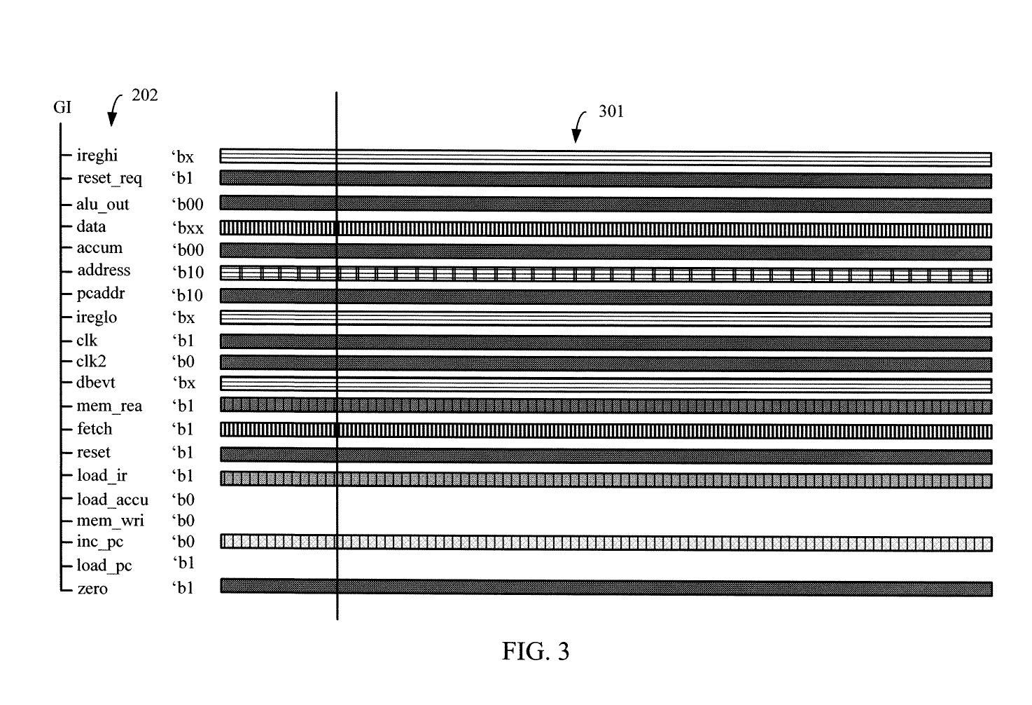

When the user zooms out to view a larger window of time, some transitions in waveforms 201 may no longer be individually represented on screen depending on the resolution of the screen (specifically, the number of pixels in the horizontal axis). Therefore, in accordance with another aspect of the invention shown in FIG. 3, when the portion of the waveform to be viewed becomes sufficiently large, a simulator can compact data of the waveform. Specifically, if more transitions appear in a waveform in a given timeframe than there are pixels to display it properly, then the associated information can be displayed in a way that indicates underlying activity, but the underlying data itself can be deleted.

In one embodiment, a set of compacted waveforms 301 can be represented by rectangles having particular colors or having particular fill patterns. Depending on the window indicated by the user, compacted waveforms 301 may have multiple underlying activities and thus have rectangles with multiple colors/fill patterns (shown in FIG. 3 as different gray tones with horizontal or vertical line patterns). In one embodiment, another set of compacted waveforms 301 can be similarly represented to indicate no underlying activity (a constant value), e.g. rectangles having no fill pattern or no rectangles at all.

Referring back to FIG. 1, the waveform images can be computed in the memory of waveform servers 105 using arrays of data, transformed into bitmaps 106, and then loaded into waveform viewer 106. This limited computing and loading is called localized rendering herein. In contrast, conventional waveform image generation entails globalized rendering, i.e. all waveform data is converted into images. Localized rendering can significantly reduce the processing time for waveform image generation by a factor of 100 to 10,000 compared to globalized rendering, depending on the data set size.

Typically, a bitmap can be represented on-screen (via waveform viewer 106) as a black (or any other color) background with colored lines forming the foreground. Each bitmap can provide a different color. Therefore, a screen having three colors in the foreground would be generated by three bitmaps. Note that one bitmap can provide image data for multiple waveforms that may be designated for viewing by the user.

Note that although bitmaps are described in detail above, the present invention can generate any type of image map suitable for the waveform viewer. Therefore, other embodiments of the waveform servers may generate JPEG files, pixmaps, PPMs (portable pixmap format), PGMs (portable graymap format), PBMs (portable bitmap format), PNMs (portable anymap format), or any other type of image format. In yet another embodiment, an instruction set can be used instead of an image format. In this case, the waveform server can direct the client to form piece-wise-linear (PWL) functions, such as line segments, shapes formed from lines (e.g. rectangles), or combinations of lines and shapes (e.g. a line followed by a rectangle). Exemplary formats using PWL functions can include XML formats, HDML formats, and text formats.

In addition to localized rendering, scrolling can also advantageously limit the amount of data that is loaded onto the client. Specifically, in a large IC design, thousands of signals may be involved. However, because of the vertical resolution of waveform viewer 106, only a subset of those signals (e.g. a hundred signals) may be shown (see FIGS. 2 and 3 for an exemplary set of signals 202). As a result, the data from only a limited number of waveforms is loaded from the waveform servers to the waveform viewer. Notably, a save and cache process can be used when scrolling, wherein the data associated with the signals that are no longer seen can be deleted, the data associated with the signals still seen can be temporarily saved (i.e. cached), and only the data associated with those additional signals added to the bottom of the list need to be loaded. Note that the user, once given information on the signals present in the design (typically in combination with a schematic showing the components generating those signals), may also select specific signals for viewing.

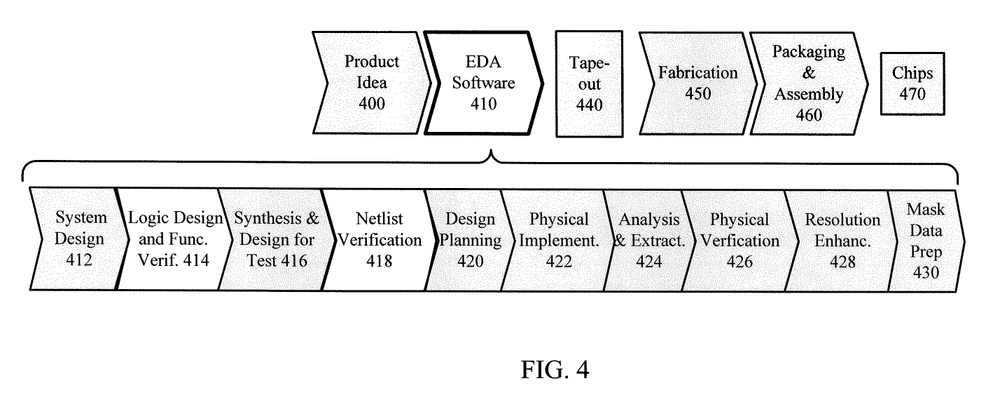

FIG. 4 shows a simplified representation of an exemplary digital ASIC design flow. At a high level, the process starts with the product idea (step 400) and is realized in an EDA software design process (step 410). When the design is finalized, it can be taped-out (event 440). After tape out, the fabrication process (step 450) and packaging and assembly processes (step 460) occur resulting, ultimately, in finished chips (result 470).

The EDA software design process (step 410) is actually composed of a number of steps 412-430, shown in linear fashion for simplicity. In an actual ASIC design process, the particular design might have to go back through steps until certain tests are passed. Similarly, in any actual design process, these steps may occur in different orders and combinations. This description is therefore provided by way of context and general explanation rather than as a specific, or recommended, design flow for a particular ASIC.

A brief description of the components steps of the EDA software design process (step 410) will now be provided:

System design (step 412): The designers describe the functionality that they want to implement, they can perform what-if planning to refine functionality, check costs, etc. Hardware-software architecture partitioning can occur at this stage. Exemplary EDA software products from Synopsys, Inc. that can be used at this step include Model Architect, Saber, System Studio, and DesignWare® products.

Logic design and functional verification (step 414): At this stage, the VHDL or Verilog code for modules in the system is written and the design is checked for functional accuracy. More specifically, does the design as checked to ensure that produces the correct outputs. Exemplary EDA software products from Synopsys, Inc. that can be used at this step include VCS, VERA, DesignWare®, Magellan, Formality, ESP and LEDA products. In one embodiment, the above-described localized rendering of the waveform images can be performed in step 414.

Synthesis and design for test (step 416): Here, the VHDL/Verilog is translated to a netlist. The netlist can be optimized for the target technology. Additionally, the design and implementation of tests to permit checking of the finished chip occurs. Exemplary EDA software products from Synopsys, Inc. that can be used at this step include Design Compiler®, Power Compiler, Tetramax, and DesignWare® products.

Netlist verification (step 418): At this step, the netlist is checked for compliance with timing constraints and for correspondence with the VHDL/Verilog source code. Exemplary EDA software products from Synopsys, Inc. that can be used at this step include Formality, PrimeTime, and VCS products. In one embodiment, the above-described localized rendering of the waveform images can also be performed in step 418.

Design planning (step 420): Here, an overall floorplan for the chip is constructed and analyzed for timing and top-level routing. Exemplary EDA software products from Synopsys, Inc. that can be used at this step include Astro and IC Compiler products.

Physical implementation (step 422): The placement (positioning of circuit elements) and routing (connection of the same) occurs at this step. Exemplary EDA software products from Synopsys, Inc. that can be used at this step include the Astro and IC Compiler products.

Analysis and extraction (step 424): At this step, the circuit function is verified at a transistor level, this in turn permits what-if refinement. Exemplary EDA software products from Synopsys, Inc. that can be used at this step include AstroRail, PrimeRail, Primetime, and Star RC/XT products.

Physical verification (step 426): At this step various checking functions are performed to ensure correctness for: manufacturing, electrical issues, lithographic issues, and circuitry. Exemplary EDA software products from Synopsys, Inc. that can be used at this step include the Hercules product.

Resolution enhancement (step 428): This step involves geometric manipulations of the layout to improve manufacturability of the design. Exemplary EDA software products from Synopsys, Inc. that can be used at this step include Proteus, ProteusAF, and PSMGen products.

Mask data preparation (step 430): This step provides the “tape-out” data for production of masks for lithographic use to produce finished chips. Exemplary EDA software products from Synopsys, Inc. that can be used at this step include the CATS(R) family of products.

Although illustrative embodiments of the invention have been described in detail herein with reference to the accompanying figures, the embodiments described herein are not intended to be exhaustive or to limit the invention to the precise forms disclosed. As such, many modifications and variations will be apparent.

For example, although the waveforms shown in the figures relate to digital signals, other embodiments may also or alternatively refer to analog signals. Note that such embodiments may provide special indicators when a spike in an analog signal is compacted, e.g. a vertical line being a single pixel wide, assuming the compaction is not overly aggressive.

Accordingly, it is intended that the scope of the invention be defined by the following Claims and their equivalents.

1. A method of generating waveform images comprising:
simulating an integrated circuit design;
converting simulated output into temporally organized waveform data;
providing localized rendering of the temporally organized waveform data based on user input and waveform viewer resolution; and
loading the waveform images into the waveform viewer.

2. The method of claim 1, wherein the simulating is performed by both a software tool and a hardware tool.

3. The method of claim 1, wherein the user input includes zooming and/or scrolling functions associated with the waveform viewer.

4. The method of claim 3, wherein the zooming functions include compacting the waveform images for the waveform viewer, wherein the compacting includes deleting underlying waveform data and using a visual representation indicating underlying activity.

5. The method of claim 3, wherein the scrolling functions including deleting unviewed waveform images, caching still-viewed waveform images, and loading a limited number of to-be-viewed waveform images.

6. The method of claim 1, wherein the waveform images include one of bitmaps files, JPEG files, pixmaps, PPMs (portable pixmap format), PGMs (portable graymap format), PBMs (portable bitmap format), PNMs (portable anymap format), and an instruction set.

7. A system for generating waveform images comprising:
a plurality of simulators for simulating an integrated circuit design;
a plurality of value change databases for converting simulated output into temporally organized waveform data;
a plurality of waveform servers for providing localized rendering of the temporally organized waveform data based on user input and waveform viewer resolution; and
a waveform viewer for loading of the waveform images.

8. The system of claim 7, wherein the plurality of simulators include both software and hardware tools.

9. The system of claim 7, wherein the waveform viewer includes zooming and/or scrolling buttons in a toolbar.

10. The system of claim 9, wherein use of the zooming button allows compacting of the waveform images, wherein the compacting includes deleting underlying waveform data and using a visual representation indicating underlying activity.

11. The system of claim 9, wherein use of the scrolling button triggers deleting unviewed waveform images, caching still-viewed waveform images, and loading a limited number of to-be-viewed waveform images.

12. The system of claim 7, wherein the waveform images include one of bitmaps files, JPEG files, pixmaps, PPMs (portable pixmap format), PGMs (portable graymap format), PBMs (portable bitmap format), PNMs (portable anymap format), and an instruction set.
